(19) United States
(12) Patent Application Publication
(10) Pub. No.: US 2025/0053060 A1
(43) Pub. Date: Feb. 13, 2025

(54) Integrated-Optics Waveguide Having High-Stress-Sensitivity Region

(71) Applicant: LioniX International BV, Enschede (NL)

(72) Inventors: René Gerrit HEIDEMAN, Oldenzaal (NL); Thi Lan Anh TRAN, Enschede (NL); Arnoud Sebastiaan EVERHARDT, Enschede (NL)

(21) Appl. No.: 18/794,929

(22) Filed: Aug. 5, 2024

Related U.S. Application Data
(60) Provisional application No. 63/531,111, filed on Aug. 7, 2023.

(51) Int. Cl. G02F 1/225; G02F 1/21

(52) U.S. Cl. CPC G02F 1/225; G02F 1/212

(57) ABSTRACT

Aspects of the present disclosure describe integrated-optics-based phase controllers comprising waveguides whose cores have one or more cavities, thereby enabling them to exhibit an enhanced photo-elastic effect and/or increased stress-induced deformation in at least one region. Waveguides in accordance with the present disclosure are particularly well suited for use in stress-optic phase controllers suitable for use in systems such as microwave photonics, LIDAR and the like.

### CROSS REFERENCE TO RELATED APPLICATIONS

This application claims the benefit of U.S. Provisional Application Ser. No. 63/531, 111, filed Aug. 7, 2023, entitled “Integrated-Optics Waveguide Having High-Stress-Sensitivity Region” (Attorney Docket: 142-046PR1), which is incorporated herein by reference. If there are any contradictions or inconsistencies in language between this application and one or more of the cases that have been incorporated by reference that might affect the interpretation of the claims in this case, the claims in this case should be interpreted to be consistent with the language in this case.

### TECHNICAL FIELD

The present disclosure relates to integrated optics in general and, more specifically, to controlling the phase of an optical signal propagating in a surface waveguide of a planar lightwave circuit.

### BACKGROUND

A Planar Lightwave Circuit (PLC) is an optical system comprising one or more integrated-optics-based waveguides that are disposed on the surface of a substrate, where the waveguides are typically combined to provide complex optical functionality. These “surface waveguides” (referred to herein as simply “waveguides”) typically include a core of a first material that is surrounded by a cladding comprising a second material having a refractive index that is lower than that of the first material. The change in refractive index at the interface between the materials enables internal reflection of light propagating through the core, thereby guiding the light along the length of the surface waveguide.

PLC-based devices and systems have made significant impact in many applications, such as optical communications systems, sensor platforms, solid-state projection systems, and the like. Surface-waveguide technology satisfies a need in these systems for small, reliable optical circuit components that can provide functional control over a plurality of optical signals propagating through a system. Examples include simple devices (e.g., 1×2 and 2×2 optical switches, Mach-Zehnder interferometer-based sensors, etc.), as well as more complex, matrix-based systems having multiple surface waveguide elements and many input and output ports (e.g., wavelength add-drop multiplexers, cross-connects, wavelength combiners, etc.).

Common to many such systems is a need to control the phase of one or more light signals as they propagate through the system-preferably with negligible excess loss. Phase controllers are critical components in, for example, variable attenuators and switches, as well as other devices.

Historically, integrated-optic phase controllers typically control the phase of a light signal propagating through a waveguide by virtue of the electro-optic effect, the thermo-optic effect, or the photo-elastic effect. Unfortunately, electro-optic-based phase controllers tend to have significant excess loss due to the fact that they inherently perturb the optical mode of the light signal, thereby making them unsuitable for many applications.

A TO phase controller takes advantage of the fact that the refractive index (i.e., the speed of light in a material) is temperature-dependent (referred to as the thermo-optic effect) by including a thin-film heater that is disposed on the top of the upper cladding of a surface waveguide. Electric current passed through the heater generates heat that propagates into the cladding and core materials, changing their temperature and, thus, their refractive indices. TO phase controllers have demonstrated induced phase changes greater than 2 π.

To form an optical switching element, a TO phase controller can be included in a surface waveguide element, such as a Mach-Zehnder interferometer (MZI). In an MZI switch arrangement, an input optical signal is split into two equal parts that propagate down a pair of substantially identical paths (i.e., arms) to a junction where they are then recombined into an output signal. One of the arms incorporates a TO phase controller that controls the phase of the light in that arm. By imparting a phase difference of π between the light-signal parts in the arms, the two signals destructively interfere when recombined, thereby canceling each other out to result in a zero-power output signal. When the phase difference between the light-signal parts is 0 (or n*2 π, where n is an integer), the two signals recombine constructively resulting in a full-power output signal.

A TO phase controller does not significantly affect the optical mode propagating through its underlying waveguide; therefore, they can function without significant excess loss. Unfortunately, the power consumption of a TO phase controller can be very high (>100 mW in a static situation) which requires cooling control elements in its package or limits its suitability in low-power applications. In addition, TO phase controllers are too slow for many applications because waveguide materials normally have low thermal-conductivity coefficients. As a result, the time required to heat or cool a surface waveguide structure can be very long (for example, 250 microseconds for a glass-based waveguide).

More recently, in part to address the shortcomings of thermo-optic tuning, stress-optic-based phase-tuning capability exploiting the photo-elastic effect has been demonstrated by incorporating a piezoelectric element disposed on a surface waveguide structure. By virtue of the photo-elastic effect, a stress-optic (SO) phase controller can induce a change in the refractive index of the materials of a waveguide with which it is operatively coupled by inducing a stress in the materials, as discussed in, for example, U.S. Pat. Nos. 9,221,074, 9,764,352, and 10,241,352, each of which is incorporated herein by reference. Since the piezoelectric element is external to the waveguide materials, it does not perturb the optical mode of the light signal upon which it operates; therefore, like the TO phase controller, an SO phase controller does not typically exhibit significant excess optical loss. In addition, a piezoelectric element consumes very little power and can quickly impart stress into their underlying materials. As a result, SO phase controllers are less power-hungry and faster than TO phase controllers, making them attractive for many applications.

Unfortunately, while prior-art SO phase controllers have shown a capability of inducing a 2 π phase shift on an optical signal in as little as a few microseconds and static power consumptions<1 μW, they require higher voltages than thermo-optic phase controllers and significantly greater length over which the stress must be induced in a surface waveguide. For instance, while a thermo-optic phase controller might require an interaction length of approximately 1 mm to induce a 2 π phase shift, the required interaction length for a comparable prior-art SO phase controller might be 2 cm or more. As a result, the cost associated with conventional SO phase controllers can be prohibitively high due to the large chip area required and/or expensive high-voltage drive electronics.

The need for a fast, space-efficient, lower-voltage, low-power-consumption approach to phase control of a light signal propagating in a surface waveguide remains, as yet, unmet in the prior art.

### SUMMARY

The present disclosure is directed toward integrated-optics-based phase controllers comprising waveguides that exhibit an enhanced photo-elastic effect and/or increased stress-induced deformation in at least one region. Waveguides in accordance with the present disclosure are particularly well suited for use in stress-optic phase controllers suitable for use in systems such as microwave photonics, LiDAR and the like.

Like SO-phase-controller-based photonic systems known in the prior art, a piezoelectric element disposed on top of a waveguide portion is used to impart a stress in the waveguide materials, thereby changing the refractive index of at least one of the materials. The change in refractive index change gives rise to a phase change in a light signal propagating through the waveguide portion.

In sharp contrast to the prior art, in the waveguide portion, the waveguide includes a multilayer core that includes one or more cavities located within the mode-field diameter of the light signal. The presence of these cavities enhances the effectiveness with which applied stress can induce a refractive-index change. As a result, a larger phase change for a can be realized with a shorter interaction length and/or using a lower drive voltage.

An illustrative embodiment is a variable optical attenuator comprising an asymmetric Mach-Zehnder interferometer in which an SO phase-control element is disposed on a first portion of one of its arms. The waveguide portion includes a multilayer core located between a lower cladding and an upper cladding, where the core includes a lower core, a central core, and an upper core. The lower and upper cores have a first width that defines the width of the multilayer core; however, the central core has a second width that is smaller than the first width. As a result, in the first portion, the core has a substantially “I-beam-shaped cross section.”

In some embodiments, the upper cladding includes a dome on which the stress-optic phase-control element is disposed, which gives rise to a further-enhanced photo-elastic effect in the waveguide materials.

An embodiment in accordance with the present disclosure is a phase controller comprising: a Mach-Zehnder interferometer having (1) a first arm comprising a first waveguide that includes a first waveguide portion and (2) a second arm comprising a second waveguide; and a stress-optic phase-control element disposed on the first waveguide portion; wherein the first portion includes a first core that is a multilayer core that includes a central core disposed between a lower core and an upper core, the central core having a first width and at least one of the lower core and the upper core having a second width that is greater than the first width.

An embodiment in accordance with the present disclosure is an apparatus comprising a phase controller that includes: a first waveguide portion for guiding a light signal characterized by a mode field having a mode-field diameter, wherein the first waveguide portion is disposed on a substrate and includes a first core that includes at least one cavity that is located within the mode-field diameter; and a first stress-optic phase-control (SOPC) element disposed on the first waveguide portion, wherein the first SOPC element is configured to induce a first stress in the first core, and wherein the first SOPC element includes: first and second electrodes; and a first piezoelectric layer that is electrically coupled with each of the first and second electrodes.

Another embodiment in accordance with the present disclosure is a method comprising forming a phase controller via operations including: forming a first waveguide for guiding a light signal characterized by a mode field having a mode-field diameter, wherein the first waveguide is formed on a substrate such that the first waveguide includes a first waveguide portion having a first core that comprises at least one cavity that is located within the mode-field diameter; and forming a first stress-optic phase-control (SOPC) element on the first waveguide portion, wherein the first SOPC element is configured to induce a first stress in the first core, and wherein the first SOPC element is formed such that it includes: first and second electrodes; and a piezoelectric layer disposed between the first and second electrodes.

### BRIEF DESCRIPTION OF THE DRAWINGS

FIG. 1 depicts a schematic drawing of a top view of a PLC-based variable optical attenuator comprising an SO phase controller in accordance with the present disclosure.

FIG. 2 depicts a schematic drawing of a cross-sectional view of a waveguide in accordance with the present disclosure.

FIGS. 3A-B depict a schematic drawing and photo-illustration of a scanning-electron micrograph, respectively, of a cross-sectional view of a phase controller comprising a waveguide portion characterized by an enhanced photo-elastic-effect in accordance with the present disclosure.

FIG. 4 depicts operations of a method suitable for forming a phase controller in accordance with the present disclosure.

FIGS. 5A-D depict schematic drawings of cross-sectional views of phase controller 104 at different points in its fabrication in accordance with the present disclosure.

FIG. 6 depicts measured phase shifts for a phase controller in accordance with the present disclosure.

FIG. 7 depicts a schematic drawing of a cross-sectional view of an alternative phase controller in accordance with the present disclosure.

FIG. 8A depicts a top view of a core of a waveguide portion in which central core 208′ has been tapered to extinction in accordance with the present disclosure.

FIGS. 8B-C depict sectional views of core region 800 taken through core 304 and narrow region 804, respectively.

FIG. 9 depicts operations of a first alternative method for forming a waveguide portion having at least one sub-region in which central core 208′ is completely removed in accordance with the present disclosure.

FIGS. 10A-D depict schematic drawings of sectional views of waveguide portion 1000 at different points in method 900 in accordance with the present disclosure.

### DETAILED DESCRIPTION

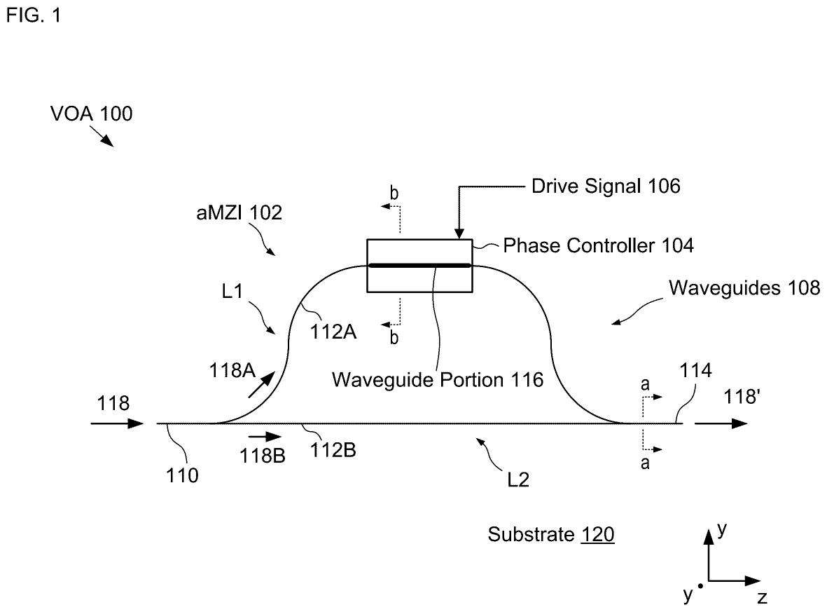

FIG. 1 depicts a schematic drawing of a top view of a PLC-based variable optical attenuator comprising an SO phase controller in accordance with the present disclosure. Variable optical attenuator (VOA) 100 includes an asymmetric Mach-Zehnder interferometer (aMZI) 102 and a phase controller 104, which are arranged to control the intensity of a light signal propagating through the VOA via drive signal 106.

aMZI 102 includes an arrangement of waveguides 108 disposed on substrate 120. In the depicted example, substrate 120 is a silicon wafer; however, substrate 120 can be any suitable substrate, such as a compound semiconductor wafer, glass substrate, or myriad alternative substrates suitable for use in planar-processing fabrication. Waveguides 108 are arranged to define input port 110, arms 112A and 112B, and output port 114.

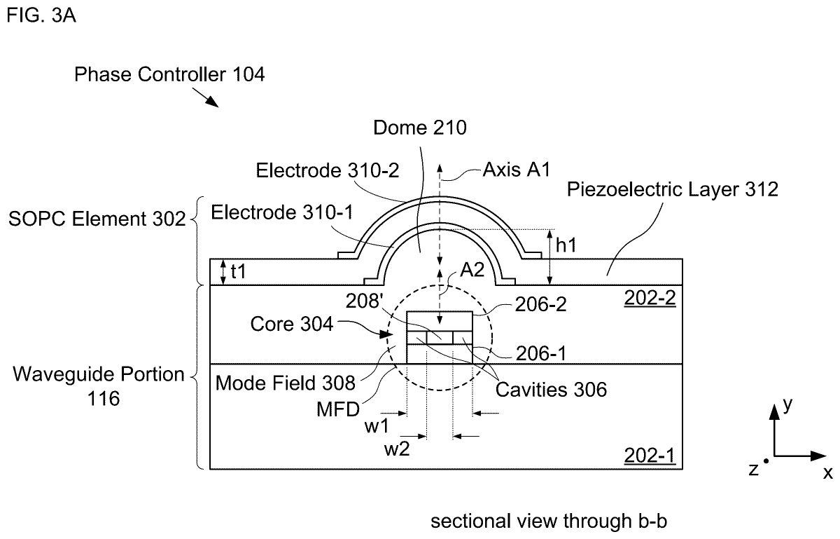

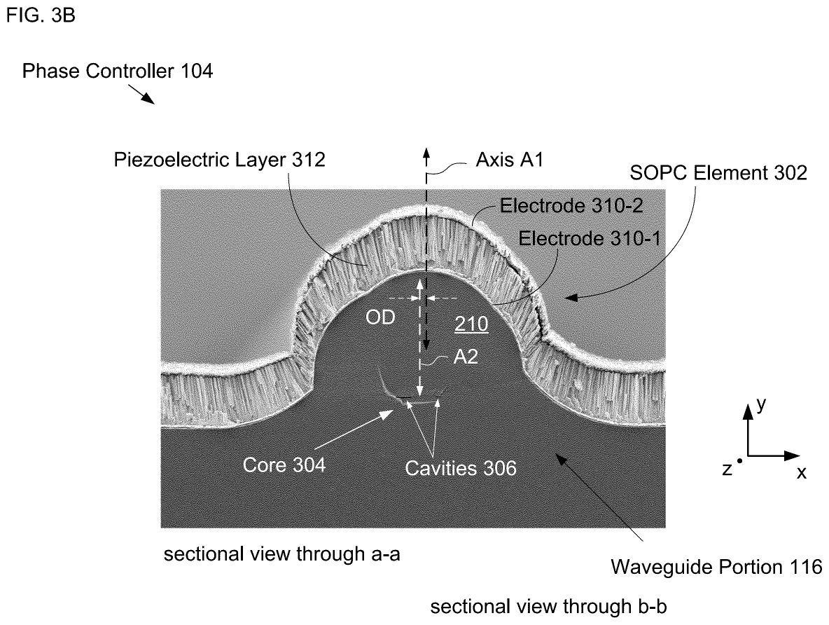

Arm 112A is a waveguide 108 that is operatively coupled with phase controller 104, which includes a stress-optic phase control element disposed on waveguide portion 116. Arm 112A has length L1, which is different than length L2. Waveguide portion 116 is a section of waveguide 108 that is configured to enhance the effect of applied stress on the refractive indices of its waveguide materials (i.e., the photo-elastic effect). Waveguide portion 116 is described in more detail below and with respect to FIG. 3.

Arm 112B is a waveguide 108 having length L2.

Although the depicted example includes a phase controller only in arm 112A, in some embodiments, a phase controller is included only in arm 112B. In some embodiments, a phase controller is included in each of arms 112A and 112B.

Each of input port 110 and output port 114 is a waveguide y-junction at which a section of waveguide 108 is optically coupled with arms 112A and 112B. In some embodiments, at least one of input port 110 and output port 114 is a different waveguide combiner, such as a directional coupler, and the like.

In operation, input light signal 118 is received at input port 110 and evenly split into light portions 118A and 118B, which propagate through arms 112A and 112B, respectively.

While light portion 118B propagates through arm 112A, its phase is controlled at phase controller 104, as described below.

Light portions 118A and 118B are then recombined and the composite signal is provided at output port 114 as output light signal 118′. As will be appreciated by one skilled in the art, the intensity of output light signal 118′ is based on the relative phases of light portions 118A and 118B when they recombine. By enabling a phase shift of at least 2 π at phase controller 104, the intensity of output light signal 118′ can be controlled over a range from substantially zero to the intensity of input light signal 118 (neglecting any propagation losses in waveguides 108).

Although the depicted example includes an asymmetric Mach-Zehnder Interferometer (MZI), in some embodiments, a system includes a symmetric MZI. In some embodiments, a phase controller in accordance with the present disclosure is operatively coupled with an integrated-optics system other than an MZI.

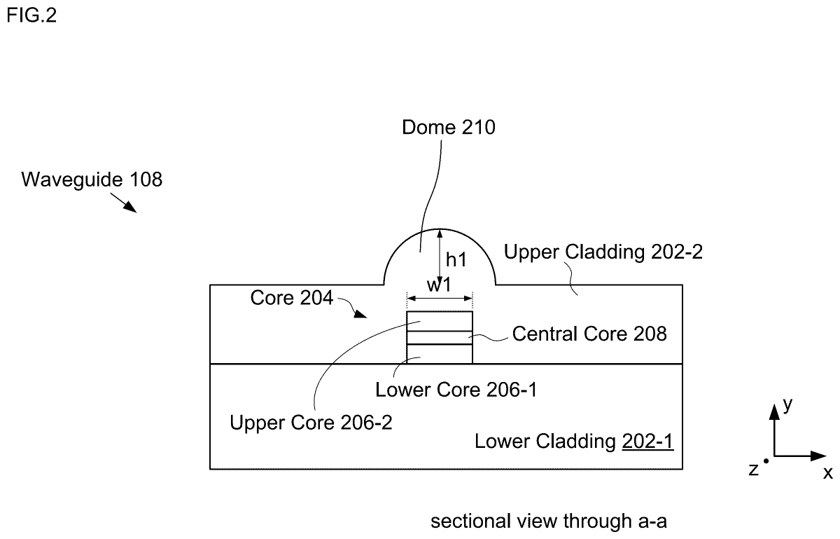

FIG. 2 depicts a schematic drawing of a cross-sectional view of a waveguide in accordance with the present disclosure. Waveguide 108 is an integrated-optics-based waveguide that includes lower cladding 202-1, core 204, and upper cladding 202-2. In the depicted example, each of lower cladding 202-1 and upper cladding 202-2 is a layer of silicon dioxide. The nominal thicknesses of lower cladding 202-1 and upper cladding 202-2 are 8 microns and 3 microns, respectively. The sectional view shown in FIG. 2 is taken through line a-a, as depicted in FIG. 1.

In the depicted example, core 204 is an asymmetric double-stripe (ADS) TriPlex™ waveguide core comprising lower core 206-1, central core 208, and upper core 206-2, each of which has width, w1. In the depicted example, width, w1, of waveguide 108 is equal to approximately 1 micron; however, other waveguide widths can be used without departing from the scope of the present disclosure.

FIGS. 3A-B depict a schematic drawing and photo-illustration of a scanning-electron micrograph, respectively, of a cross-sectional view of a phase controller comprising a waveguide portion characterized by an enhanced photo-elastic-effect in accordance with the present disclosure. Phase controller 104 includes waveguide portion 116 and stress-optic phase-control (SOPC) element 302. The sectional views shown in FIG. 3A-B are taken through line b-b, as depicted in FIG. 1. It should be noted that the phase controller example shown in FIG. 3B is characterized by an “offset dome.” As noted below, in some embodiments, a lateral offset of the centers of a dome and its underlying waveguide core can enhance the photo-elastic effect; however, in many cases, it is preferred that the dome and core or concentric.

Waveguide portion 116 is a section of arm 112A in which the core of waveguide 108 includes one or more cavities within its core. Specifically, waveguide portion 116 includes core 304, which is analogous to core 204; however, core 304 includes central core 208′, which has width w2, where w2 is smaller than width w1 of lower core 206-1 and upper core 206-2. The narrower width of central core 208′ gives rise to cavities 306, which enhance the photo-electric effect that can be induced in the waveguide portion. In the depicted example, w2 is equal to 0.5 microns and core 304 has a substantially I-beam cross-section. It should be noted that this value of w2 is merely exemplary and, typically, it is only necessary that central core 208′ be narrower than upper core 206-2 to give rise to cavities 306.

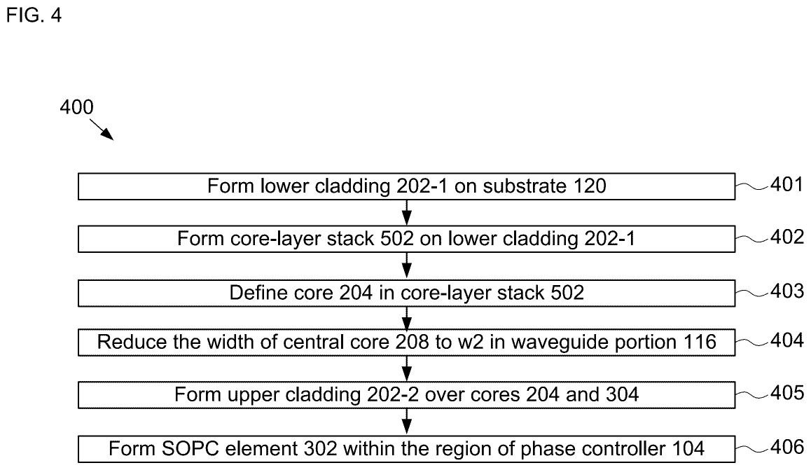

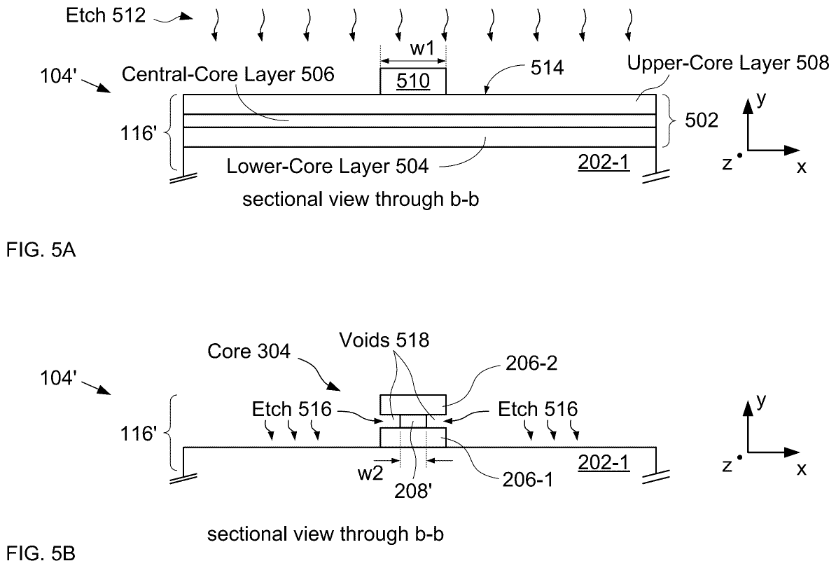

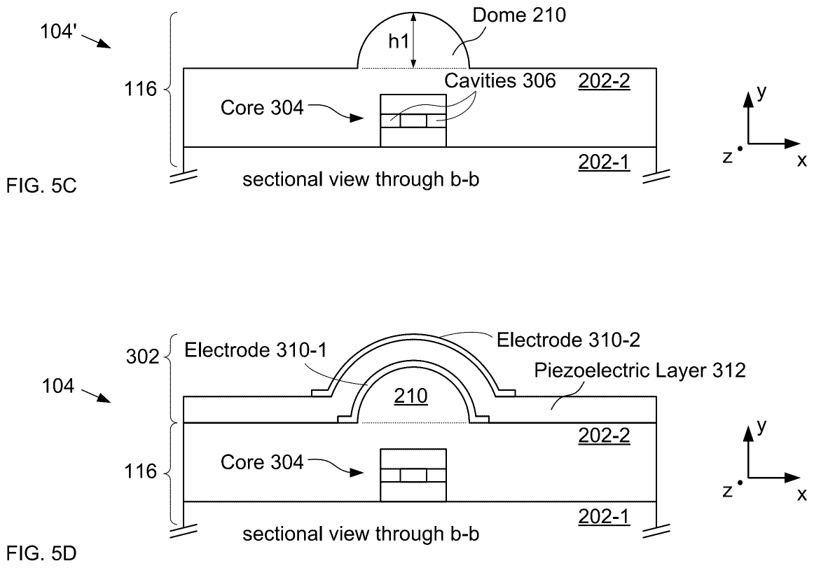

FIG. 4 depicts operations of a method suitable for forming a phase controller in accordance with the present disclosure. Method 400 is described with continuing reference to FIGS. 1 and 3A-B, as well as reference to FIGS. 5A-D. Method 400 begins with operation 401, wherein lower cladding 202-1 is formed on substrate 120.

FIGS. 5A-D depict schematic drawings of sectional views of phase controller 104 at different points in its fabrication in accordance with the present disclosure. The sectional views shown in FIGS. 5A-D are taken through line b-b, as depicted in FIG. 1.

Lower cladding 202-1 is formed in conventional fashion such that it has a desired thickness—typically, a thickness sufficient to mitigate optical coupling of light from the core into the substrate. In the depicted example, lower cladding 202-1 is a layer of silicon dioxide having a thickness of approximately 8 microns.

At operation 402, core-layer stack 502 is formed on lower cladding 202-1 in conventional fashion. Core-layer stack 502 includes lower-core layer 504, central-core layer 506, and upper-core layer 508 as shown.

In the depicted example, lower-core layer 504 is a layer of stoichiometric silicon nitride having a thickness of 75 nm, central-core layer 506 is a layer of stoichiometric silicon dioxide having a thickness of approximately 100 nm, and upper-core layer 508 is a layer of stoichiometric silicon dioxide having a thickness of approximately 175 nm. However, any suitable material(s) and/or thickness(es) can be used for any of lower-core layer 504, central-core layer 506, and upper-core layer 508 without departing from the scope of the present disclosure.

At operation 403, the shapes (i.e., lateral dimensions) of waveguides 108 of aMZI 102 are defined by patterning core-layer stack 502 via conventional lithography mask 510 and reactive-ion etch 512. It should be noted that operation 405 also exposes the sidewalls of central core 208.

FIG. 5A depicts a schematic drawing of a sectional view of nascent phase controller 104′ during operation 405. Although FIG. 5A depicts etch 512 stopping perfectly at top surface 514 of lower cladding 202-1, in some embodiments, etch 512 continues to etch into top surface 514 for some distance. It should be noted that, at this point in method 400, lower core 206-1, central core 208, and upper core 206-2 of nascent waveguide portion 116 all have width w1.

At operation 404, in the region of phase controller 104, the width of central core 208 in waveguide portion 116 is reduced to w2 by exposing its sidewalls to etch 516. During operation 404, etch 516 attacks the exposed sidewalls of central core 208, thereby undercutting upper core 206-2 and forming voids 518. In the depicted example, w2 is approximately etch 0.5 micron and etch 516 is a wet etch of buffered oxide etch (BOE); however, any suitable value for w2 and/or etch can be used without departing from the scope of the present disclosure.

FIG. 5B depicts a schematic drawing of a sectional view of nascent phase controller 104′ during operation 404. It should be noted that etch 516 typically also etches top surface 514 of lower cladding 202-1 and slightly undercuts core 304; however, for clarity, this is not depicted here.

At operation 405, upper cladding 202-2 is formed over cores 204 and 304, thereby completing waveguide 108 and waveguide portion 116. In the depicted example, upper cladding 202-2 is formed such that it comprises silicon dioxide and has a thickness of approximately 3 microns.

It should be noted that the dimensions provided herein for the cladding and core layers of waveguide 108 and waveguide portion 116 are merely exemplary and that any suitable materials and thicknesses can be used for any of lower cladding 202-1, lower core 206-1, central cores 208 and 208′, upper core 206-2, and upper cladding 202-2 without departing from the scope of the present disclosure.

During the formation of upper cladding 202-2, its material is deposited such that core 304 becomes encased in upper-cladding material, thereby pinching off voids 518 to define cavities 306 within core 304. Furthermore, in waveguide 108 and waveguide portion 116, upper cladding 202-2 includes dome 210, which is located above core 204 and has height h1. In the depicted example, height h1 is equal to 820 nm. As discussed below, the presence of dome 210 can enhance the photo-elastic effect in waveguide portion 116.

By virtue of cavities 306, core 304 is more easily deformed by the application of stress, enhancing the photo-elastic effect that can be induced.

In some embodiments, core 304 includes a cavity on only one side of central core 208′, while in other embodiments, core 304 includes different sized cavities on either side of central core 208′. Still further, in some embodiments, one or more cavities 306 are located above and/or below core 304 in addition to, or instead of, the cavities depicted here, which are located laterally adjacent to central core 208′.

FIG. 5C depicts a schematic drawing of a sectional view of nascent phase controller 104′ after the completion of waveguide portion 116.

Waveguide portion 116 is dimensioned and arranged such that a light signal propagating through the waveguide portion is characterized by mode field 308, the diameter of which is larger than core 304. As a result, cavities 306 are located, at least partially, within the diameter of the mode field, as depicted in FIG. 3A.

It is an aspect of the present disclosure that the presence of cavities within the mode-field diameter of a light signal propagating through a waveguide portion causes that waveguide portion to exhibit a greater photo-elastic effect and/or increased stress-induced deformation in response to applied stress. In other words, the presence of cavities 306 within mode field 308 enables a greater change in refractive index to be induced in waveguide portion 116 for a given applied stress, as compared to a change that would be induced in a comparable waveguide that does not include cavities 306.

It should be noted that, although the depicted example includes a waveguide portion having equal-width lower and upper cores, in some embodiments, the widths of the lower and upper cores are different. It is an aspect of the present disclosure, however, that including a central core having a width that is smaller than that of the upper core gives rise to at least one cavity below the upper core that results in an enhanced photo-elastic effect for a waveguide.

In some embodiments, at least one of lower and upper cores includes etched features that further enhance the photo-elastic effect. Still further, in some embodiments, the central core is completely removed from a waveguide portion in at least one region.

At operation 406, SOPC element 302 is formed over dome 210 in the region of phase controller 104.

SOPC element 302 is a stress-optic phase-control element comprising bottom electrode 310-1, piezoelectric layer 312, and top electrode 310-2, where the bottom electrode is in physical and electrical contact with the bottom surface of piezoelectric layer 312 and the top electrode is in physical and electrical contact with top surface of the piezoelectric layer. In the depicted example, electrodes 310-1 and 310-2 comprise platinum and have thicknesses of 200 nm and 300 nm, respectively, while piezoelectric layer 312 comprises lead zirconate titanate (PZT) and has a thickness, t1, of 1.5 microns. It should be noted that the materials and dimensions provided above are merely exemplary and that any suitable materials and thicknesses can be used for any of bottom electrode 310-1, piezoelectric layer 312, and top electrode 310-2 without departing from the scope of the present disclosure. Exemplary alternative materials suitable for use in piezoelectric layer 312 include, without limitation, barium titanate, lead titanate, lithium niobate, bismuth ferrite, sodium niobate, and the like.

In the depicted example, upper cladding 202-2 includes an optional dome feature (i.e., dome 210) disposed above core 304. As a result, SOPC element 302 is disposed on upper cladding 202-2 such that electrodes 310-1 and 310-2 are disposed over the extent of dome 210. In some embodiments, the electrodes extend laterally in the x-direction by more or less distance than depicted in FIG. 3. In some embodiments, upper cladding 202-2 does not include dome 210 and, instead, has a substantially planar top surface such that SOPC element 302 is also substantially planar. In some embodiments, central axis A1 of dome 210 is laterally offset (along the x-direction as shown in FIG. 3B) from the central axis A2 of core 304 by a nonzero offset distance OD.

FIG. 5D depicts a schematic drawing of a sectional view of phase controller 104 after formation of SOPC element 302. It should be noted that bond pads and/or electrical connections to electrodes 310-1 and 310-2 are typically included in phase controller 104; however, these are not shown herein for clarity.

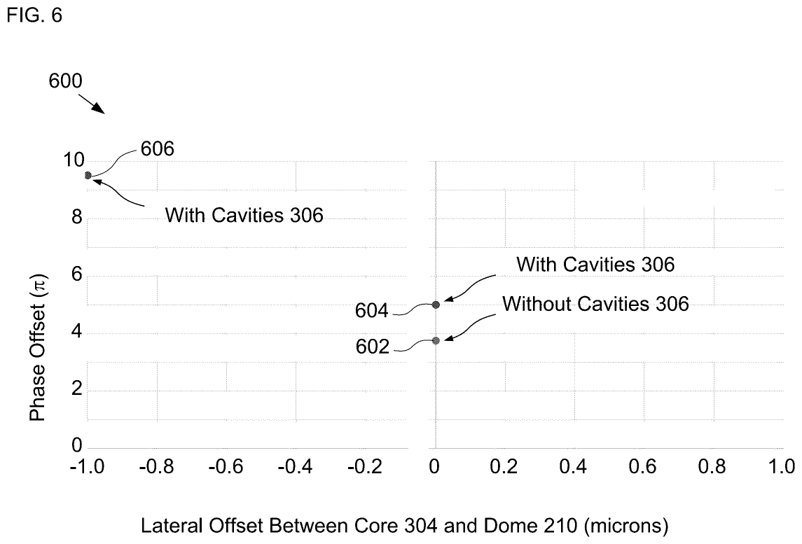

FIG. 6 depicts measured phase shifts for phase controllers having different configurations in accordance with the present disclosure. Plot 600 depicts measured phase shifts induced in a waveguide portion analogous to waveguide portion 116 by an SOPC element analogous to SOPC element 302 for three different phase controller configurations. For each configuration, the SOPC element has a length of 1 cm and the waveguide portion has a core that is 1.4 microns wide and a dome height of 4 microns. All values were measured using a 40 V drive signal.

Data points 602 and 604 demonstrate that the introduction of cavities 306 into a phase controller can significantly improve its performance. Specifically, data point 602 shows a phase change of approximately 3.5 π is induced on a light signal traversing a phase controller having no cavities 306 and no lateral offset between the centers of core 304 and dome 210, while data point 604 shows that a phase change of approximately 5 π is induced by substantially the same structure including cavities 306.

Data point 606 shows a phase change of approximately 9.5 π is induced on a light signal traversing a phase controller that includes cavities 306 and also has a lateral offset between the centers of core 304 and dome 210 of 1 micron along the x-direction. However, it should be noted that, in at least some embodiments, a phase controller having cavities and a dome that is well-aligned with the core of its waveguide will potentially exhibit an even larger phase change than that shown here for the misaligned dome/core structure.

It should be further noted that SOPC element 302 of phase controller 104 has a “top-bottom” electrode configuration in which piezoelectric layer 312 resides between a pair of electrodes located above and below its piezoelectric material. In some embodiments in accordance with the present disclosure, however, an SOPC element has a “top-top” electrode configuration in which both of its electrodes are located on the top surface of piezoelectric layer 312. Some examples of top-top SOPC elements are described in detail in U.S. patent application Ser. No. 17/988,653, filed Nov. 29, 2022 (Attorney Docket: 142-043US1), which is incorporated herein by reference.

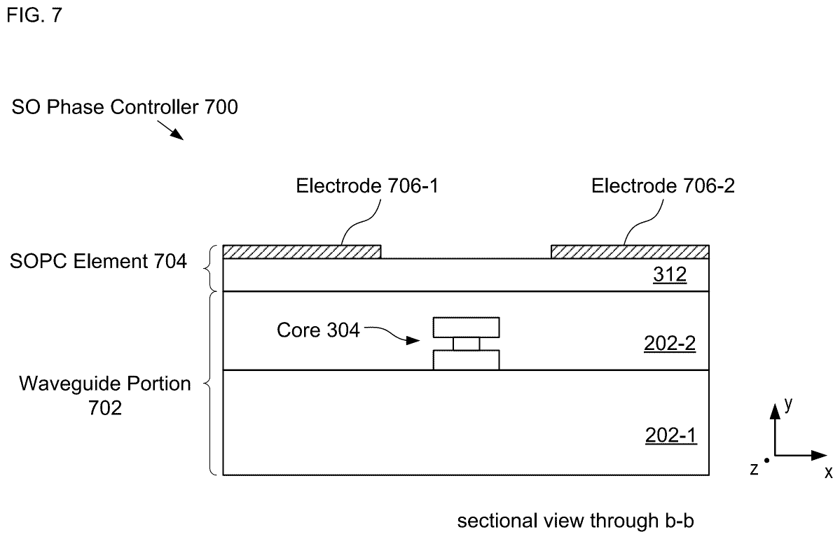

FIG. 7 depicts a schematic drawing of a cross-sectional view of an alternative phase controller in accordance with the present disclosure. Phase controller 700 includes waveguide portion 702 and SOPC element 704, which has a top-top electrode configuration. The sectional view shown in FIG. 7 is analogous to that taken through line b-b, as depicted in FIG. 1.

Waveguide portion 702 is analogous to waveguide portion 116 described above; however, waveguide portion 602 does not include a dome structure over core 304. In some embodiments, however, waveguide portion 702 does include a dome structure in its upper cladding, such as dome 210.

SOPC element 704 is disposed on the top surface of upper cladding 202-2 and includes piezoelectric layer 312 and electrodes 706-1 and 706-2.

Electrodes 706-1 and 706-2 are analogous to electrodes 310-1 and 310-2 described above.

In operation, in response to an applied electrical signal, SOPC element 704 induces significant tensile stress into the upper cladding and core layers of waveguide portion 702.

As will be understood by one skilled in the art, after reading this specification, an abrupt change in central-core width from w1 to w2 is typically undesirable as it will likely give rise to significant loss for a signal propagating through a waveguide. As a result, although not indicated in FIG. 1, the interfaces between waveguides 108 and waveguide portion 116 are characterized by adiabatic taper regions on either side of waveguide portion 116, at which the width of central core 208 slowly changes between w1 and w2. Typically, such width tapering occurs as part of the wet-etch step used to narrow central core 208.

In some embodiments, additional (or alternative) tapering of the width of central core 208′ near the middle region of waveguide portion 116 is performed to further enhance the photo-elastic effect that can be induced. In fact, in some embodiments, central core 208 is tapered to extinction, such that it is eliminated within at least one area of waveguide portion 116.

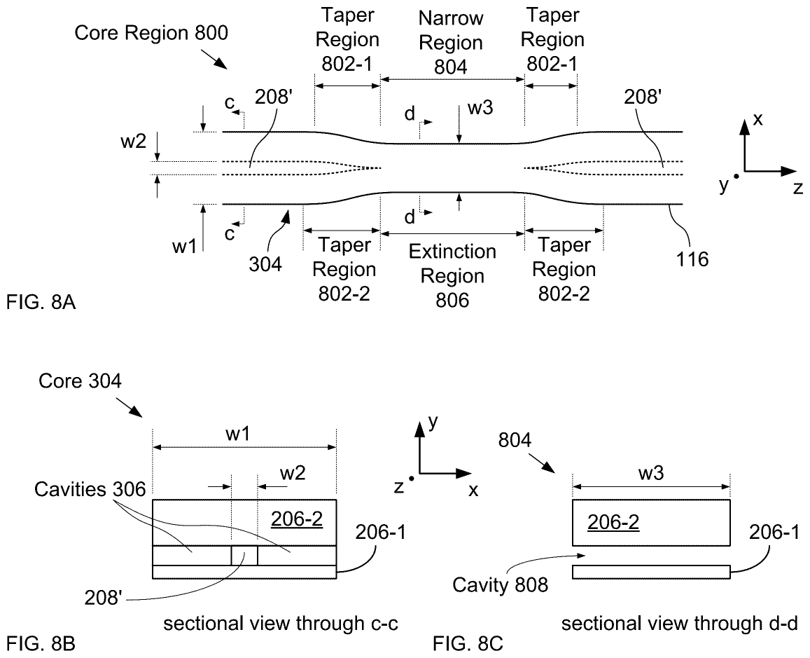

FIG. 8A depicts a top view of a core of a waveguide portion in which central core 208′ has been tapered to extinction in accordance with the present disclosure. Core region 800 is a sub-region of core 304 described above and includes taper regions 802-1 and 802-2, narrow region 804, and extinction region 806.

FIGS. 8B-C depict sectional views of core region 800 taken through core 304 and narrow region 804, respectively. The sectional views depicted in FIGS. 8B-C are taken through lines c-c and d-d, respectively, as shown in FIG. 8A.

Each of taper regions 802-1 and 802-2 includes lower core 206-1, central core 208′, and upper core 206-2. Lower and upper claddings 202-1 and 202-2 are not shown for clarity.

In order to realize taper regions 802-2 and extinction region 806, the mask used to define the lateral dimensions of core of waveguides 108 during operation 403 includes features for defining taper regions 802-1 and narrow region 804 such that the width of all of the layers of core 304 are is gradually reduced from w1 to w3. In some embodiments, only the width of upper core 206-2 is reduced in tapers 802-1.

As a result, the lateral etch distance required for etch 516 to reduce the width of central core 208′ to w2 outside of core region 800 in operation 404, gives rise to taper regions 802-2 in which the width of central core 208′ is gradually reduced from w2 to extinction. In other words, in narrow region 804, etch 516 fully undercuts upper core 206-2 and completely remove central core 208′.

Within narrow region 804, therefore, relatively smaller cavities 306 are joined to define a single, full-channel-width cavity 808, which provides a significantly larger photo-elastic effect. Furthermore, deleterious effects of the presence of cavities on propagation loss through the waveguide is substantially insignificant.

In the depicted example, w1 is 1.4 microns, w2 is 0.2 micron, and w3 is 1.2 microns; however, any practical value can be used for any of w1, w2, and w3 without departing from the scope of the present disclosure.

It should be noted that the above is merely one exemplary method for forming a waveguide portion that includes full-channel-width cavities and that alternative methods can be used without departing from the scope of the present disclosure.

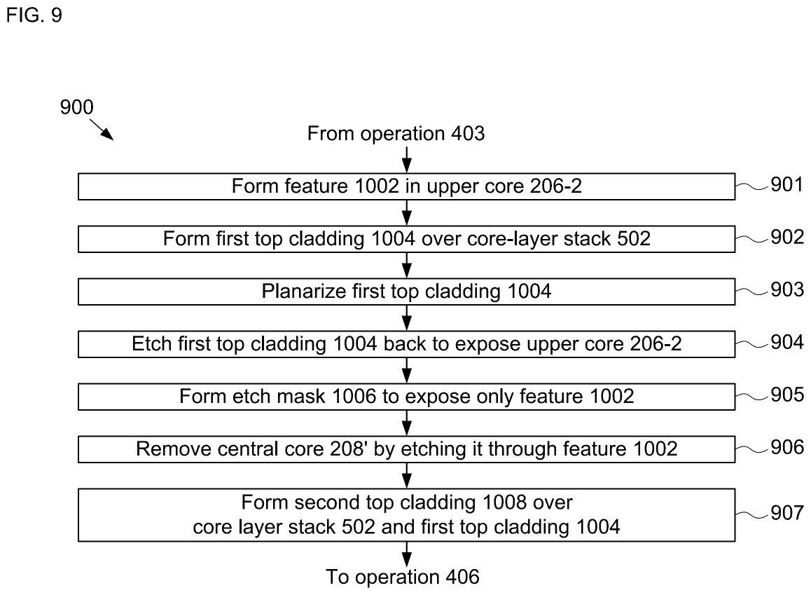

FIG. 9 depicts operations of a first alternative method for forming a waveguide portion having at least one sub-region in which central core 208′ is completely removed in accordance with the present disclosure.

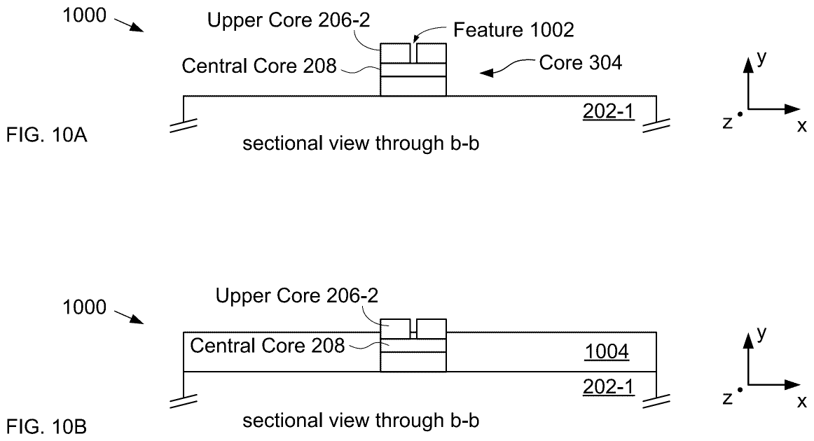

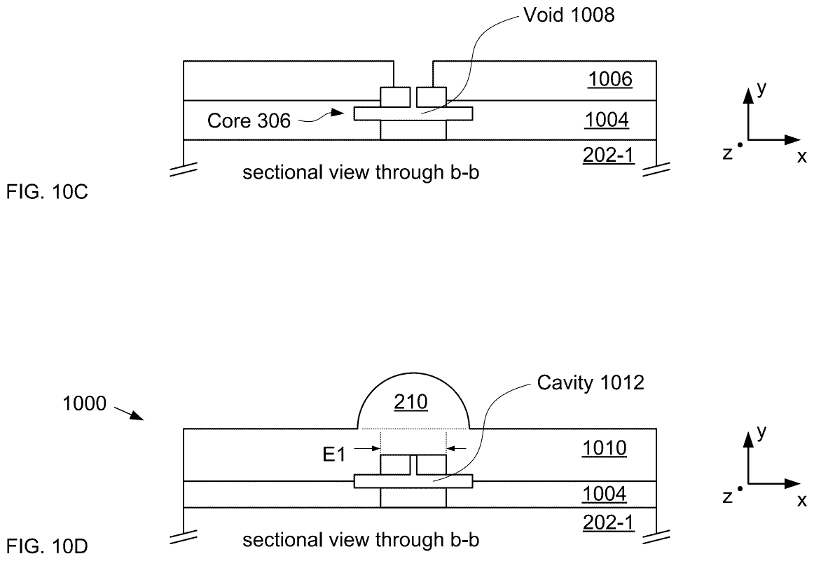

FIGS. 10A-D depict schematic drawings of sectional views of waveguide portion 1000 at different points in method 900 in accordance with the present disclosure. The sectional views shown in FIGS. 10A-D are taken through line b-b, as depicted in FIG. 1.

Method 900 begins with operations 401 through 403 of method 400. Upon completion of operation 403, method 900 continues with operation 901, wherein conventional lithography and etching is used to form feature 1002 through upper core 206-2 to expose central core 208.

FIG. 10A depicts a schematic drawing of a sectional view of nascent waveguide portion 1000 after operation 901.

At operation 902, first top cladding 1004 is formed over core 306.

At operation 903, first top cladding 1004 is planarized in conventional fashion, such as by using a chemical-mechanical polish (CMP).

At operation 904, first top cladding 1004 is etched back to expose upper core 206-2. Typically, operation 904 is terminated when the surface of the first top cladding is at approximately the midpoint of upper core 206-2.

FIG. 10B depicts a schematic drawing of a sectional view of nascent waveguide portion 1000 after operation 904.

At operation 905, form etch mask 1006 such that it selectively exposes feature 1002.

At operation 906, the entirety of central core 208′ is removed by etching it in a suitable wet etch through feature 1002, thereby forming void 1008. In some embodiments, operation 906 is allowed to continue after the complete removal of the central core such that voids 1008 extend outside the width of core 306, as shown in FIG. 10C.

FIG. 10C depicts a schematic drawing of a sectional view of nascent waveguide portion 1000 after formation of void 1008.

At operation 907, second top cladding 1010 is formed over core-layer stack 502, thereby pinching off void 1008 to form cavity 1012 and completing waveguide portion 1000.

FIG. 10D depicts a schematic drawing of a sectional view of nascent waveguide portion 1000 after the formation of second top cladding 1010.

Upon completion of operation 907, method 900 continues with operation 406 to complete the fabrication of a phase controller in accordance with the present disclosure.

It is to be understood that the disclosure teaches just one example of the illustrative embodiment and that many variations of embodiments in accordance with the present disclosure can easily be devised by those skilled in the art after reading this disclosure and that the scope of the present invention is to be determined by the following claims.

What is claimed is:

1. An apparatus comprising a phase controller that includes:
a first waveguide portion for guiding a light signal characterized by a mode field having a mode-field diameter, wherein the first waveguide portion is disposed on a substrate and includes a first core that includes at least one cavity that is located within the mode-field diameter; and
a first stress-optic phase-control (SOPC) element disposed on the first waveguide portion, wherein the first SOPC element is configured to induce a first stress in the first core, and wherein the first SOPE element includes:
first and second electrodes; and
a first piezoelectric layer that is electrically coupled with each of the first and second electrodes.

2. The apparatus of claim 1 further including a plurality of waveguides disposed on the substrate, the plurality of waveguides being arranged to collectively define a Mach-Zehnder interferometer having an input port, an output port, a first arm that includes a first waveguide of the plurality thereof, and a second arm comprising a second waveguide of the plurality thereof, wherein the first waveguide includes the first waveguide portion.

3. The apparatus of claim 2 wherein the first arm has a first length and the second arm has a second length that is different than the first length.

4. The apparatus of claim 2 wherein the second waveguide includes:
a second waveguide portion for guiding the light signal, the second waveguide portion including a second core that includes at least one cavity that is located within the mode-field diameter; and
a second SOPC element disposed on the second waveguide portion, wherein the second SOPC element is configured to induce a second stress in the second core, and wherein the second SOPE element includes:
third and fourth electrodes; and
a second piezoelectric layer that is electrically coupled with each of the third and fourth electrodes.

5. The apparatus of claim 1 wherein the first core includes:
a lower core comprising a first material;
a central core comprising a second material; and
an upper core comprising the first material;
wherein the upper core has a first width and the central core has a second width that is less than the first width; and
wherein the at least one cavity is at least partially located between the lower core and the upper core.

6. The apparatus of claim 5 wherein the first width defines an extent of the upper core along a first direction, and wherein the at least one cavity extends beyond the extent of the upper core along the first direction.

7. The apparatus of claim 5 wherein the first core has a cross-sectional shape that is an I-beam.

8. The apparatus of claim 1 wherein the first core is located between a lower cladding and an upper cladding, and wherein the upper cladding includes a dome that is located above the first core, the first SOPC element being disposed on the dome.

9. The apparatus of claim 8 wherein the dome has a first central axis and the first core has a second central axis, and wherein the first and second central axes are displaced along a first dimension by a nonzero offset distance.

10. A method comprising forming a phase controller via operations including:
forming a first waveguide for guiding a light signal characterized by a mode field having a mode-field diameter (MFD), wherein the first waveguide is formed on a substrate such that the first waveguide includes a first waveguide portion having a first core that comprises at least one cavity that is located within the mode-field diameter; and
forming a first stress-optic phase-control element on the first waveguide portion, wherein the first stress-optic phase-control element is configured to induce a first stress in the first core, and wherein the first stress-optic phase-control element is formed such that it includes:
first and second electrodes; and
a piezoelectric layer disposed between the first and second electrodes.

11. The method of claim 10 further comprising forming a plurality of waveguides on the substrate, wherein the plurality of waveguides is arranged to define a Mach-Zehnder Interferometer having an input port, a first arm that includes the first waveguide, a second arm, and an output port.

12. The method of claim 11 wherein the plurality of waveguides is formed such that the first arm has a first length and the second arm has a second length that is different than the first length.

13. The method of claim 10 wherein the first waveguide is formed such that the first core includes:
a lower core comprising a first material;
a central core comprising a second material; and
an upper core comprising the first material;
wherein the upper core has a first width and the central core has a second width that is less than the first width; and
wherein the at least one cavity is at least partially located between the lower core and the upper core.

14. The method of claim 10 further comprising forming an upper cladding on the first core such that the upper cladding includes a dome that is disposed above the first core, and wherein the first SOPC control element is disposed on the dome.

15. The method of claim 14 wherein the dome is formed such that it has a first central axis, and wherein the first core is formed such that it has a second central axis, wherein the first and second central axes are displaced along a first dimension by a nonzero offset distance.
